(19) United States
(12) Patent Application Publication
(10) Pub. No.: US 2007/0246951 A1
(43) Pub. Date: Oct. 25, 2007

(54) Gate latch with steel insert

(76) Inventor: David M. Thompson, Bricktown, NJ (US)

Correspondence Address: Andrew W. Ludy, 17 Sherwood Way, Landing, NJ, 07850, US

(21) Appl. No.: 11/407,789

(22) Filed: Apr. 20, 2006

(51) Int. Cl. E05C 3/04

(52) U.S. Cl. 292/210

(57) ABSTRACT

A gate latch is for use in connection with a pontoon boat having a handrail with a gate and at least one jamb. The jamb has a predetermined width and depth, and a mounting hole through it. The gate latch has a gate stop with a front plate commensurate with the jamb width. The gate stop has a rear plate longer than the jamb width. A transverse plate extends from the front plate to the rear plate, commensurate with the jamb depth. The gate stop front and rear plates have holes through them aligned with the jamb mounting hole, to mount the gate stop on the jamb with a single threaded fastener. The gate latch has a latch arm with a knob for grasping, and is mounted on the gate stop front plate with the single threaded fastener for pivotal movement from a generally upright latch open position to a generally lateral latch closed position. A detent is provided for selectively holding the latch arm in the upright and the lateral positions. The gate stop and the latch arm are each molded from either a thermoplastic or a thermoset resin. Metal inserts are disposed within the molded gate stop and within the molded latch arm, so as to strengthen the gate stop and the latch arm.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) This invention relates to the field of gate latches, and more particularly to a plastic gate latch with a steel insert, especially for use in connection with a handrail on a pontoon boat.

(2) Some examples of pontoon boat gate latches known in the art are seen in the following examples.

(3) Huntley, U.S. Pat. No. 6,854,414, shows a sliding bolt type of latch. This latch rattles when the vessel is underway, has an excessive number of parts, and it is not very attractive. In the event that the bolt becomes corroded or bent, the latch will become difficult to operate.

(4) Putman, U.S. Pat. No. 6,443,088, illustrates a lift gate latch. The gate is lifted upward on the hinge pins, elevating the gate clear of the latch pocket, to open or close the gate. The hinge pins could jam, making the gate difficult to lift. The gate could rattle in the latch pocket when the boat is underway.

(5) Accordingly, there is a need to provide a pontoon boat gate latch that has a minimum number of parts for simple installation.

(6) There is a further need to provide a pontoon boat gate latch of the type described and that will not jam, bend, or corrode.

(7) There is a yet further need to provide a pontoon boat gate latch of the type described and that is easy to operate.

(8) There is a still further need to provide a pontoon boat gate latch of the type described and that will not rattle when the vessel is underway.

(9) There is another need to provide a pontoon boat gate latch of the type described and that can be quickly and easily installed with only a single fastener required.

(10) There is yet another need to provide a pontoon boat gate latch of the type described and that will meet the recommendations of the ABYC (American Boat and Yacht Council) and the NMMA (National Marine Manufacturer's Association) for minimum breaking strength of 400 lb (181 kg) in all directions.

(11) There is still another need to provide a pontoon boat gate latch of the type described and that can be tightened temporarily for shipping the boat, so that the gate does not open in transit, then loosened for proper operation when the boat is delivered.

(12) There is an additional need to provide a pontoon boat gate latch of the type described and that can be manufactured cost-effectively in large quantities of high quality.

### BRIEF SUMMARY OF THE INVENTION

(13) In accordance with the present invention, there is provided a gate latch for use in connection with a pontoon boat. The pontoon boat has a handrail with a gate and at least one jamb. The jamb has a predetermined width, a predetermined depth, and a mounting hole through it. The gate latch comprises a gate stop having a front plate extending from a proximal end to a distal end. The distance between the front plate proximal end and the front plate distal end is generally commensurate with the jamb predetermined width. The gate stop has a rear plate extending from a proximal end to a distal end. The distance between the rear plate proximal end and the rear plate distal end is greater than the jamb predetermined width. The gate stop has a transverse plate extending from the front plate proximal end to the rear plate proximal end. The distance between the front plate proximal end and the rear plate proximal end is generally commensurate with the jamb predetermined depth. The gate stop front plate has a hole through it. The gate stop rear plate has a hole through it that is collinear with the front plate hole. The front and rear plate holes are adapted for alignment with the jamb mounting hole, so as to be able to mount the gate stop on the jamb. The jamb mounting hole is off-center for strength.

(14) The gate latch includes a latch arm, which extends from a proximal end to a distal end. The latch arm has a front aspect and an opposite rear aspect. The latch arm has a knob projecting outward from the front aspect at the distal end for manual grasping. The latch arm has a button projecting outward from the rear aspect at the distal end for contact with the gate. The knob projects outward further than the button. The latch arm can thus be reversed to fit 1 ⅛ or 1 ¼ inch jamb material. The proximal end has a hole through it. The hole is adapted to pivotally mount the latch arm on the gate stop front plate for pivotal movement from a generally upright latch open position, wherein the gate will be free to open, to a generally lateral latch closed position, wherein the gate will be captured between the latch arm and the gate stop rear plate.

(15) Pivotal means is provided for pivotal mounting of the latch arm proximal end on the gate stop front plate. A detent means is provided for selectively holding the latch arm in the generally upright position and in the generally lateral position.

(16) The gate stop and the latch arm are each molded from either a thermoplastic resin or a thermoset resin. The gate stop includes a metal insert disposed within the molded gate stop, so as to strengthen the gate stop. The latch arm includes a metal insert disposed within the molded latch arm, so as to strengthen the latch arm.

### BRIEF DESCRIPTION OF THE SEVERAL VIEWS OF THE DRAWING

(17) A more complete understanding of the present invention may be obtained from consideration of the following description in conjunction with the drawing, in which:

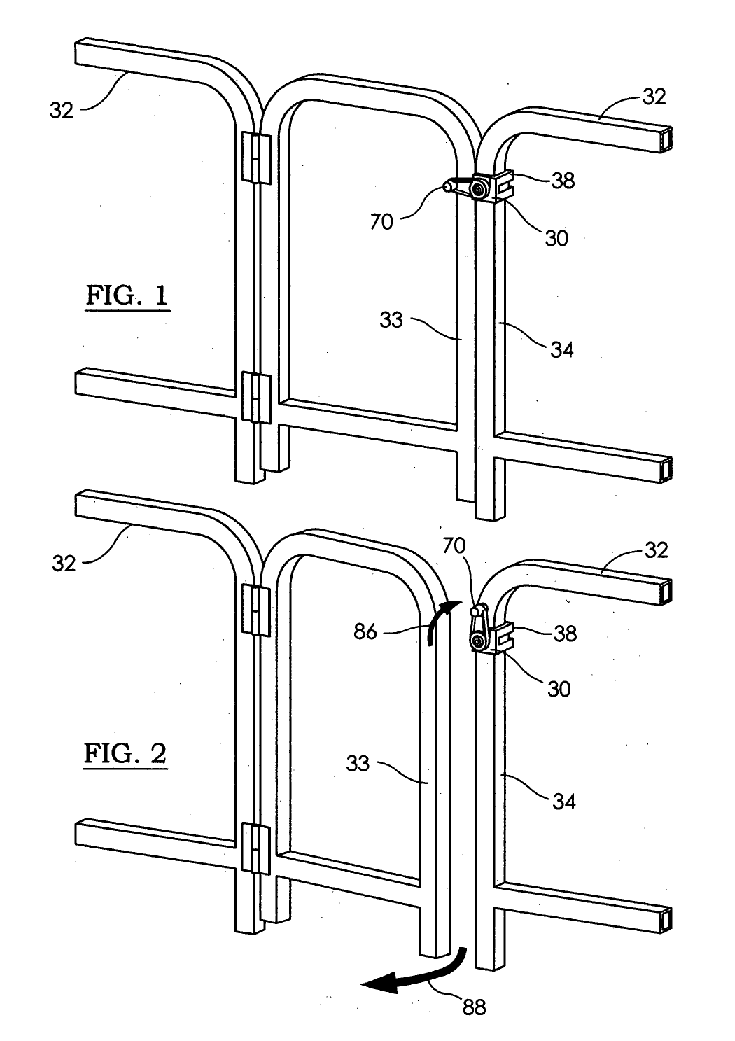

(18) FIG. 1 is a perspective view of a gate latch constructed in accordance with the invention, and showing installation of the gate latch on a gate and handrail, with the latch in the closed position;

(19) FIG. 2 is another perspective view of the gate latch of FIG. 1, with the latch in the open position;

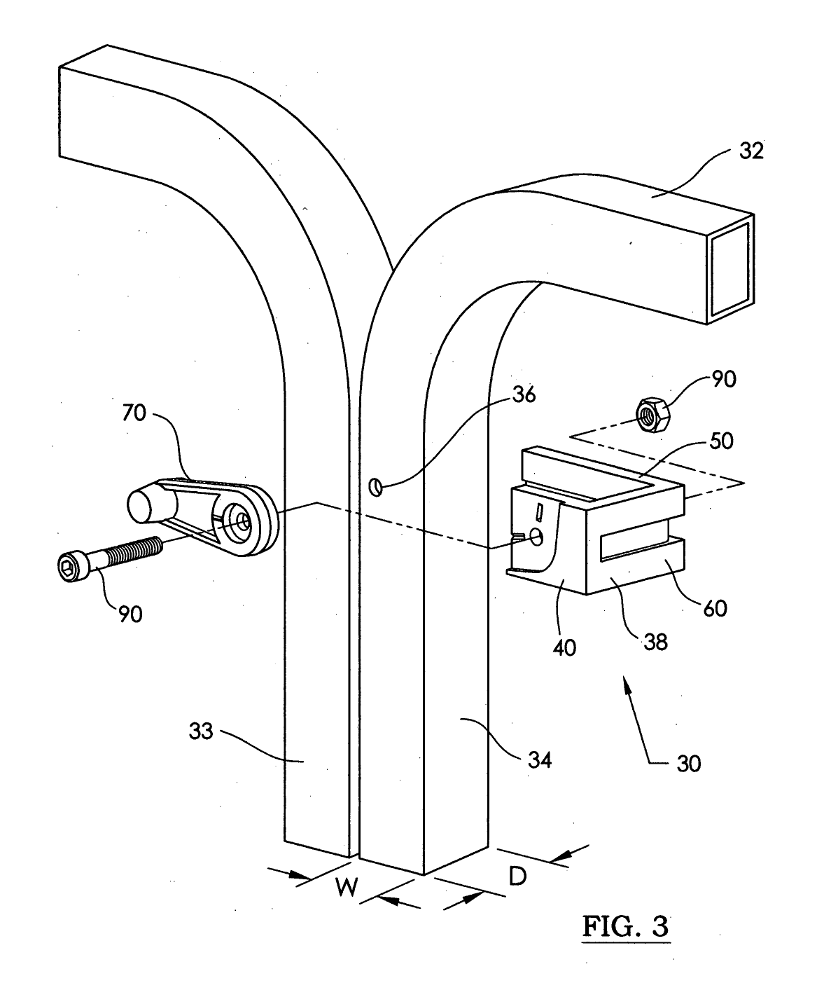

(20) FIG. 3 is a close-up exploded perspective view of the gate latch of FIG. 1;

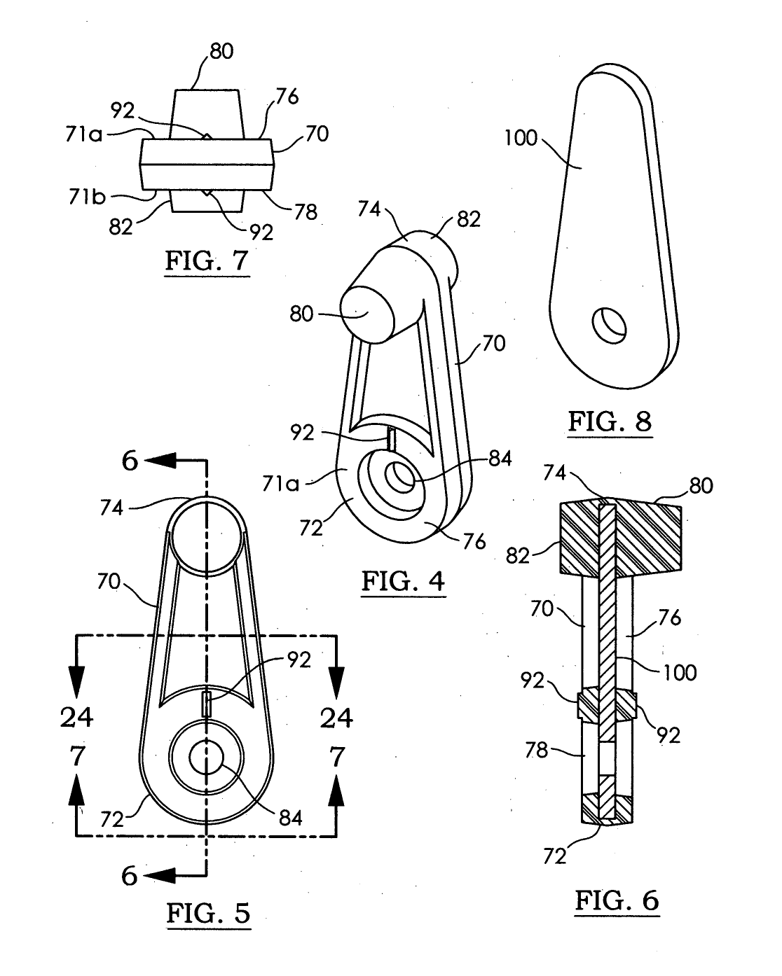

(21) FIG. 4 is a close-up perspective view of a latch arm of the gate latch of FIG. 1;

(22) FIG. 5 is a front elevational view of the latch arm of FIG. 4;

(23) FIG. 6 is a fight side cross-sectional elevational view of the latch arm of FIG. 4, taken along lines 6-6 of FIG. 5;

(24) FIG. 7 is a bottom view of the latch arm of FIG. 4, taken along lines 7-7 of FIG. 5;

(25) FIG. 8 is a perspective view of a metal insert disposed inside of the latch arm of FIG. 4;

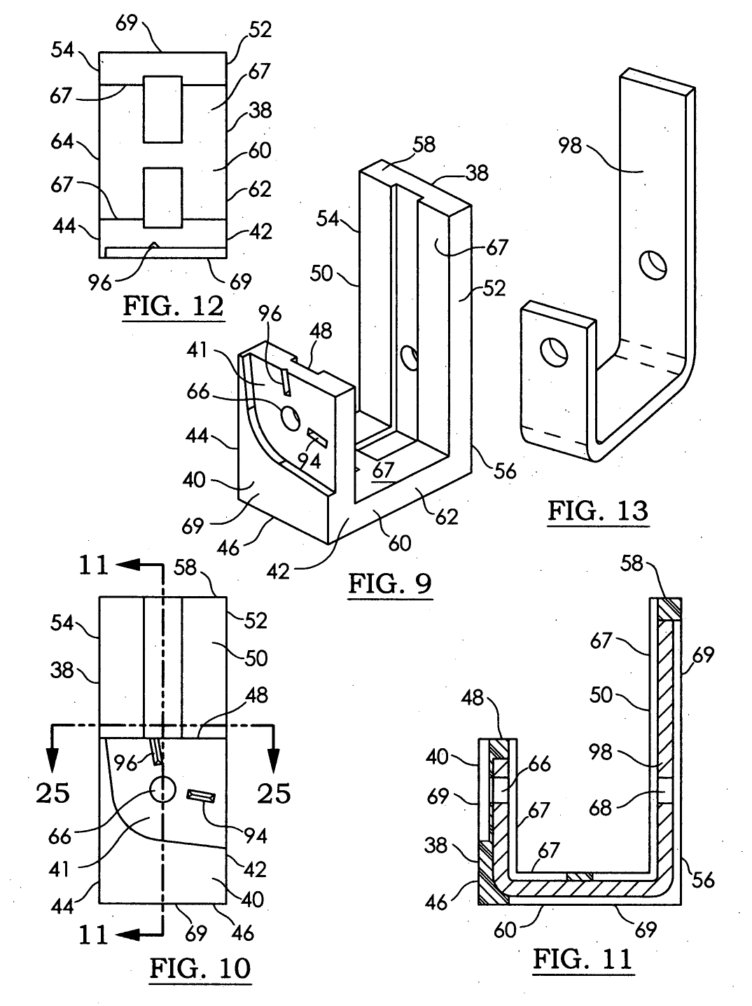

(26) FIG. 9 is a close-up perspective view of a gate stop of the gate latch of FIG. 1;

(27) FIG. 10 is a front elevational view of the gate stop of FIG. 9;

(28) FIG. 11 is a right side cross-sectional elevational view of the gate stop of FIG. 9, taken along lines 11-11 of FIG. 10;

(29) FIG. 12 is a top view of the gate stop of FIG. 9;

(30) FIG. 13 is a perspective view of a metal insert disposed inside of the gate stop of FIG. 9;

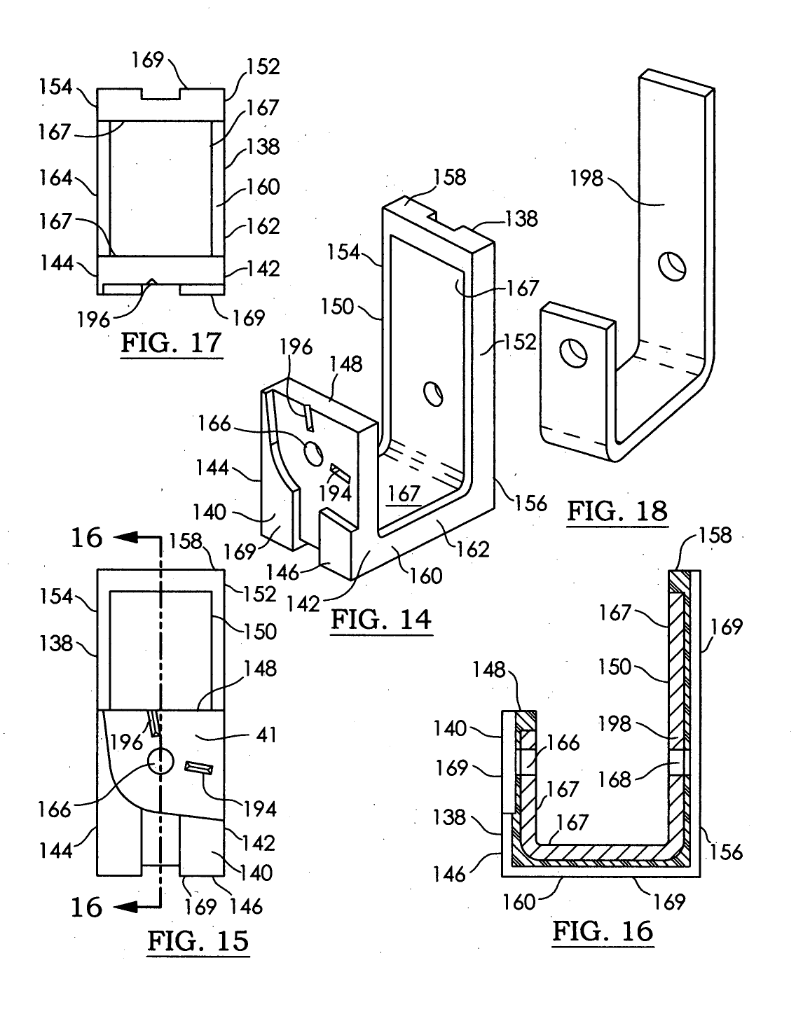

(31) FIG. 14 is a close-up perspective view of a gate stop of another gate latch constructed in accordance with the invention;

(32) FIG. 15 is a front elevational view of the gate stop of FIG. 14;

(33) FIG. 16 is a right side cross-sectional elevational view of the gate stop of FIG. 14, taken along lines 16-16 of FIG. 15;

(34) FIG. 17 is a top view of the gate stop of FIG. 14;

(35) FIG. 18 is a perspective view of a metal insert disposed inside of the gate stop of FIG. 14;

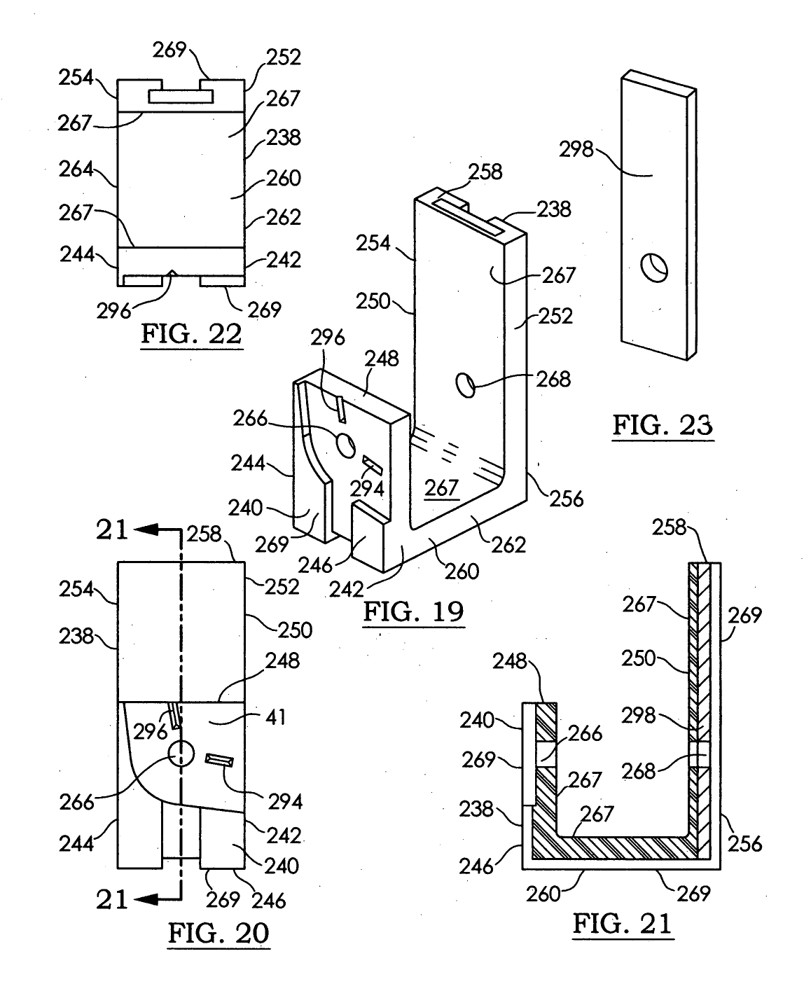

(36) FIG. 19 is a close-up perspective view of a gate stop of yet another gate latch constructed in accordance with the invention;

(37) FIG. 20 is a front elevational view of the gate stop of FIG. 19;

(38) FIG. 21 is a right side cross-sectional elevational view of the gate stop of FIG. 19, taken along lines 21-21 of FIG. 20;

(39) FIG. 22 is a top view of the gate stop of FIG. 19;

(40) FIG. 23 is a perspective view of a metal insert disposed inside of the gate stop of FIG. 19;

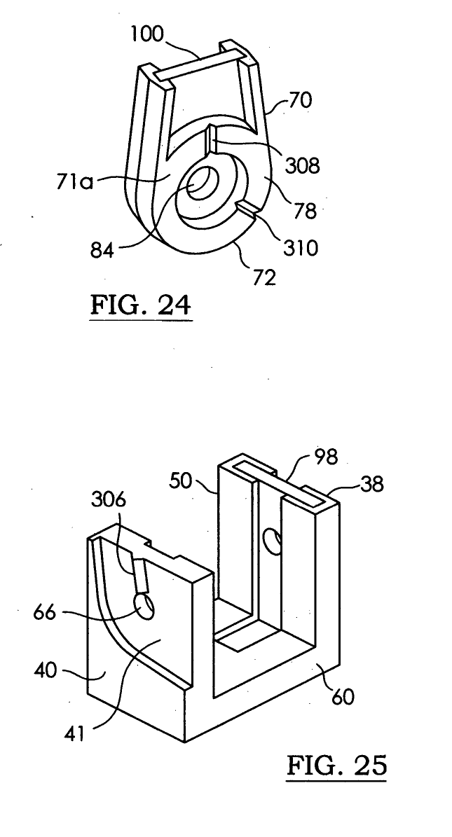

(41) FIG. 24 is a cross-sectional perspective view of the latch arm of FIG. 4, taken along lines 24-24 of FIG. 5, and showing another detent; and

(42) FIG. 25 is a cross-sectional perspective view of the gate stop of FIG. 9, taken along lines 25 - 25 of FIG. 10, and showing another detent.

### DETAILED DESCRIPTION OF THE INVENTION

(43) Referring now to the drawing, and especially to FIGS. 1-13 thereof, a gate latch is shown at 30, and is for use in connection with a pontoon boat (not shown). The pontoon boat has a handrail 32 with a gate 33 and at least one jamb 34. The jamb 34 has a predetermined width W and a predetermined depth D, as shown in FIG. 3. The jamb 34 has a mounting hole 36 through it. The jamb mounting hole 36 is drilled off-center, placing it nearer the tube sidewall for strength. The gate latch 30 comprises a gate stop 38, having a front plate 40 extending between opposite upper 42 and lower 44 edges and extending from a proximal 46 end to a distal 48 end. The distance between the front plate proximal end 46 and the front plate distal end 48 is generally commensurate with the jamb predetermined width W. The gate stop 38 has a rear plate 50 extending between opposite upper 52 and lower 54 edges and extending from a proximal end 56 to a distal end 58. The distance between the rear plate proximal end 56 and the rear plate distal end 58 is greater than the jamb predetermined width W. The gate stop 38 has a transverse plate 60 extending between opposite upper 62 and lower 64 edges and extending from the front plate proximal end 46 to the rear plate proximal end 56. The distance between the front plate proximal end 46 and the rear plate proximal end 56 is generally commensurate with the jamb predetermined depth D. The gate stop front plate 40 has a hole 66 through it. The gate stop rear plate 50 has a hole 68 through it that is collinear with the front plate hole 66. The front 66 and rear 68 plate holes are adapted for alignment with the jamb mounting hole 36, so as to be able to mount the gate stop 38 on the jamb 34. The gate stop 38 has an inside surface 67 and an outside surface 69.

(44) The gate latch 30 includes a latch arm 70, which extends from a proximal end 72 to a distal end 74. The latch arm 70 has a front aspect 76 and an opposite rear aspect 78. The latch arm 70 has a knob 80 projecting outward from the front aspect 76 at the distal end 74 for manual grasping. The latch arm 70 has a button 82 projecting outward from the rear aspect 78 at the distal end 74 for contact with the gate 33. The latch arm 70 can be mounted in a reversed position, so that the knob 80 contacts the gate 33, and the button 82 is manually grasped. In this manner, the gate latch can be used for either 1 ⅛ inch or 1 ¼ inch jamb material, both commonly used tubing sizes. The proximal end 72 has a hole 84 through it. The hole 84 is adapted to pivotally mount the latch arm 70 on the gate stop front plate 40 for pivotal movement from a generally upright latch open position as shown by arrow 86 in FIG. 2, wherein the gate 33 will be free to open as shown by arrow 88, to a generally lateral latch closed position as shown in FIG. 1, wherein the gate 33 will be captured between the latch arm 70 and the gate stop rear plate 50.

(45) Pivotal means is provided for pivotal mounting of the latch arm proximal end 72 on the gate stop front plate 40. In the preferred embodiment, a threaded fastener 90 is adapted for passing through the latch arm hole 84 and the gate stop front plate hole 66 and the jamb mounting hole 36 and the gate stop rear plate hole 68. The threaded fastener 90 will pivotally fasten the latch arm 70 to the gate stop front plate 40. The single threaded fastener 90 will also fasten the gate stop 38 to the jamb 34. It is to be understood that any fastener, such as a rivet, can be used. Placing the jamb mounting hole 36 off-center and closer to the gate allows use of a shorter latch arm 70. This results in less leverage and a lower bending moment in the latch arm 70 and in the threaded fastener 90.

(46) A detent is provided for selectively holding the latch arm 70 in the generally upright position and in the generally lateral position. The front plate 40 and the latch arm 70 have mutually opposed mating faces, 41 and 71a. One of the mating faces has a ridge molded in, and the opposed of the mating faces has at least one groove, and preferably two grooves, molded in. The grooves are adapted to receive the ridge, so as to hold the latch arm 70 in either the generally upright or the generally lateral position.

(47) In one embodiment, the latch arm mating face 71a has the ridge 92 molded in adjacent the proximal end 72. The ridge 92 extends radially outward from the hole 84. The gate stop front plate mating face 41 has the grooves 94 and 96 molded in, which extend radially outward from the hole 66. The grooves 94 and 96 are adapted to receive the latch arm ridge 92. The latch arm mating face 71a or 71b can be either the front aspect 76 or the rear aspect 78 respectively, since the latch arm 70 is reversible. The ridge 92 is therefore molded into both the front 76 and rear 78 aspects, as shown in FIGS. 4, 6, and 7.

(48) In another embodiment depicted in FIGS. 24 and 25, the gate stop front plate mating face 41 has the ridge 306 molded in. The ridge 306 extends radially outward from adjacent the front plate hole 66. The latch arm mating face 71a has the grooves 308 and 310 molded in adjacent the proximal end 72. The grooves 308 and 310 extend radially outward from adjacent the latch arm hole 84. The grooves 308 and 310 are adapted to receive the front plate ridge 306. The grooves 308 and 310 are molded into both the front 76 and rear 78 aspects.

(49). The gate stop 38 and the latch arm 70 are each molded from a polymeric material selected from the group consisting of thermoplastic resins and thermoset resins. The gate stop 38 includes a metal insert 98 disposed within the molded gate stop 38, as shown in FIGS. 9, 11, and 13, so as to strengthen the gate stop 38. Stainless steel is the preferred material for the metal insert 98, but any metal can be used, such as brass, bronze, monel, galvanized steel, or aluminum. In this embodiment, the U-shaped metal insert 98 is recessed on all sides below the molded inside surface 67 and the molded outside surface 69 of the gate stop 38.

(50) The latch arm 70 includes a metal insert 100 disposed within the molded latch arm 70, so as to strengthen the latch arm 70. As before, the metal insert 100 is recessed on all sides below the surface of the molded latch arm 70.

(51) Turning now to FIGS. 14-18, as well as FIGS. 1-3, and 4-8, another gate stop is shown at 138, and is similar to gate stop 38 described above, in that gate stop 138 has a front plate 140 extending between opposite upper 142 and lower 144 edges and extending from a proximal 146 end to a distal 148 end. The gate stop 138 has a rear plate 150 extending between opposite upper 152 and lower 154 edges and extending from a proximal end 156 to a distal end 158. The gate stop 138 has a transverse plate 160 extending between opposite upper 162 and lower 164 edges and extending from the front plate proximal end 146 to the rear plate proximal end 156. The gate stop front plate 140 has a hole 166 through it. The gate stop rear plate 150 has a hole 168 through it that is collinear with the front plate hole 166. The gate stop 138 is adapted for mounting on the jamb 34 in the same manner as gate stop 38. The gate stop 138 has an inside surface 167 and an outside surface 169.

(52) The gate stop 138 is adapted for use with the same latch arm 70 as gate stop 38. The Pivotal means and the detent are the same as described above. The gate stop 138 is molded from a thermoplastic or a thermoset resin. The gate stop 138 includes a U-shaped metal insert 198 disposed within the molded gate stop 138, as shown in FIGS. 14, 16, and 18, so as to strengthen the gate stop 138. The gate stop 138 differs from gate stop 38 in that the metal insert 198 is flush on the inside with the molded inside surface 167 of the gate stop 138. The metal insert 198 is recessed on the outside below the molded outside surface 169 of the gate stop 138.

(53) Referring now to FIGS. 19-23, as well as FIGS. 1-3, and 4-8, yet another gate stop is shown at 238, and is similar to gate stop 38 described above, in that gate stop 238 has a front plate 240 extending between opposite upper 242 and lower 244 edges and extending from a proximal 246 end to a distal 248 end. The gate stop 238 has a rear plate 250 extending between opposite upper 252 and lower 254 edges and extending from a proximal end 256 to a distal end 258. The gate stop 238 has a transverse plate 260 extending between opposite upper 262 and lower 264 edges and extending from the front plate proximal end 246 to the rear plate proximal end 256. The gate stop front plate 240 has a hole 266 through it. The gate stop rear plate 250 has a hole 268 through it that is collinear with the front plate hole 266. The gate stop 238 is adapted for mounting on the jamb 34 in the same manner as gate stop 38. The gate stop 238 has an inside surface 267 and an outside surface 269.

(54) The gate stop 238 is adapted for use with the same latch arm 70 as gate stop 38. The Pivotal means and the detent are the same as described above. The gate stop 238 is molded from a thermoplastic or a thermoset resin. The gate stop 238 includes a flat metal insert 298 disposed within the molded gate stop 238, as shown in FIGS. 19, 21, and 23, so as to strengthen the gate stop 238. The gate stop 238 differs from gate stop 38 in that the metal insert 298 is straight, and is disposed inside only the rear plate 250 of the gate stop 238. The metal insert 298 is recessed on all sides below the molded inside surface 267 and the molded outside surface 269 of the gate stop 238.

(55) Referring now to FIGS. 24 and 25, as well as FIGS. 4, 5, 9, and 10, yet another detent means is provided for selectively holding the latch arm 70 in the generally upright and lateral positions. The gate stop front plate 40 has a single ridge 306 extending radially outward from the front plate hole 66. The latch arm rear face 78 has a first groove 308 adjacent the proximal end 72. The first groove 308 extends radially outward from adjacent the latch arm hole 84 in the direction of the distal end 74. The first groove 308 is adapted to receive the gate stop ridge 306 so as to hold the latch arm 70 in the generally upright position. The latch arm rear face 78 has a second groove 310 adjacent the proximal end 72. The second groove 310 extends radially outward from adjacent the latch arm hole 84. The second groove 310 is displaced angularly from the first groove 308. The second groove 310 is adapted to receive the gate stop ridge 306 so as to hold the latch arm 70 in the generally lateral position.

(56) Numerous modifications and alternative embodiments of the invention will be apparent to those skilled in the art in view of the foregoing description. It is to be understood that any of the above-described detents can be combined with any of the gate stops. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

### Parts List

### Gate Latch With Steel Insert

Part No. Description

30 gate latch

32 handrail

33 gate

34 jamb

36 jamb mounting hole

38 gate stop

40 front plate

41 front plate mating face

42 front plate upper edge

44 front plate lower edge

46 front plate proximal end

48 front plate distal end

50 rear plate

52 rear plate upper edge

54 rear plate lower edge

56 rear plate proximal end

58 rear plate distal end

60 transverse plate

62 transverse plate upper edge

64 transverse plate lower edge

66 front plate hole

67 gate stop inside surface

68 rear plate hole

69 gate stop outside surface

70 latch arm

71a latch arm mating face

71b latch arm mating face

72 latch arm proximal end

74 latch arm distal end

76 latch arm front face

78 latch arm rear face

80 knob

82 button

84 latch arm hole

86 latch open arrow

88 gate open arrow

90 threaded fastener

92 latch arm single ridge

94 front plate first groove

96 front plate second groove

98 gate stop metal insert

100 latch arm metal insert

138 gate stop

140 front plate

142 front plate upper edge

144 front plate lower edge

146 front plate proximal end

148 front plate distal end

150 rear plate

152 rear plate upper edge

154 rear plate lower edge

156 rear plate proximal end

158 rear plate distal end

160 transverse plate

162 transverse plate upper edge

164 transverse plate lower edge

166 front plate hole

167 gate stop inside surface

168 rear plate hole

169 gate stop outside surface

194 front plate first groove

196 front plate second groove

198 gate stop metal insert

238 gate stop

240 front plate

242 front plate upper edge

244 front plate lower edge

246 front plate proximal end

248 front plate distal end

250 rear plate

252 rear plate upper edge

254 rear plate lower edge

256 rear plate proximal end

258 rear plate distal end

260 transverse plate

262 transverse plate upper edge

264 transverse plate lower edge

266 front plate hole

267 gate stop inside surface

268 rear plate hole

269 gate stop outside surface

294 front plate first groove

296 first plate second groove

298 gate stop metal insert

306 gate stop ridge

308 latch arm first groove

310 latch arm second groove

1-20. (canceled)

21. A gate latch, for use in connection with a pontoon boat, the pontoon boat having a handrail with at least one jamb, the jamb having a predetermined width and a predetermined depth, the jamb having a mounting hole therethrough, the gate latch comprising:
a gate stop, the gate stop having a front plate extending between opposite upper and lower edges and extending from a proximal end to a distal end, the distance between the front plate proximal end and the front plate distal end being generally commensurate with the jamb's predetermined width, the gate stop having a rear plate extending between opposite upper and lower edges and extending from a proximal end to a distal end, the distance between the rear plate proximal end and the rear plate distal end being greater than the jamb's predetermined width, the gate stop having a transverse plate extending between opposite upper and lower edges and extending from the front plate proximal end to the rear plate proximal end, the distance between the front plate proximal end and the rear plate proximal end being generally commensurate with the jamb's predetermined depth, the gate stop front plate having a hole therethrough, the gate stop rear plate having a hole therethrough collinear with the front plate hole, the front and rear plate holes being adapted for alignment with the jamb's mounting hole, so as to be able to mount the gate stop on the jamb, the gate stop being molded from a polymeric material, the gate stop having a metal insert disposed within the molded gate stop;
a latch arm extending from a proximal end to a distal end, the latch arm having a front aspect and an opposite rear aspect, the latch arm having a knob projecting outward from the front aspect at the distal end for manual grasping, the latch arm having a button projecting outward from the rear aspect at the distal end for contact with the gate, the knob projecting outward further than the button, the latch arm being reversible so as to accommodate different size jambs, the proximal end having a hole therethrough, the hole being adapted to pivotally mount the latch arm on the gate stop front plate for pivotal movement of the latch arm from a generally upright latch open position wherein the gate will be free to open, to a generally lateral latch closed position wherein the gate will be captured between the latch arm and the gate stop rear plate, the front plate and the latch arm having mutually opposed mating faces, one of the mating faces having a ridge molded in, and the opposed of the mating faces having at least one groove molded in, the groove being adapted to receive the ridge, so as to hold the latch arm in one of the generally upright and generally lateral positions, the latch arm being molded from a polymeric material, the latch arm having a metal insert disposed within the molded latch arm; and
pivotal means for pivotal mounting of the latch arm proximal end on the gate stop front plate.

22. The gate latch of claim 21, wherein:
the gate stop metal insert further comprises a U-shaped metal insert disposed within the molded gate stop; and
the latch arm metal insert further comprises a flat metal insert disposed within the molded latch arm, so as to strengthen the gate stop and the latch arm.

23. The gate latch of claim 21, wherein:
the gate stop metal insert further comprises a flat metal insert disposed within the molded gate stop; and
the latch arm metal insert further comprises a flat metal insert disposed within the molded latch arm, so as to strengthen the gate stop and the latch arm.

24. The gate latch of claim 21, wherein the pivotal means further comprises a threaded fastener adapted for passing through the latch arm hole and the gate stop front plate hole and the jamb's mounting hole and the gate stop rear plate hole, so as to pivotally fasten the latch arm to the gate stop front plate and to fasten the gate stop to the jamb.

25. The gate latch of claim 21, wherein the gate stop polymeric material and the latch arm polymeric material are selected from the group consisting of thermoplastic resins and thermoset resins.

26. The gate latch of claim 21, further comprising:
the latch arm mating face having the ridge molded in adjacent the proximal end, the ridge extending radially outward from the hole; and
the gate stop front plate mating face having the groove molded in, the groove extending radially outward from the hole, and adapted to receive the latch arm ridge so as to hold the latch arm in position.

27. The gate latch of claim 21, further comprising:
the gate stop front plate mating face having the ridge molded in, the ridge extending radially outward from adjacent the front plate hole; and
the latch arm mating face having the groove molded in adjacent the proximal end, the groove extending radially outward from adjacent the latch arm hole, and adapted to receive the front plate ridge so as to hold the latch arm in position.

28. A gate latch, for use in connection with a pontoon boat, the pontoon boat having a handrail with at least one jamb, the jamb having a predetermined width and a predetermined depth, the jamb having a mounting hole therethrough, the gate latch comprising:
a gate stop, the gate stop having a front plate extending between opposite upper and lower edges and extending from a proximal end to a distal end, the distance between the front plate proximal end and the front plate distal end being generally commensurate with the jamb's predetermined width, the gate stop having a rear plate extending between opposite upper and lower edges and extending from a proximal end to a distal end, the distance between the rear plate proximal end and the rear plate distal end being greater than the jamb's predetermined width, the gate stop having a transverse plate extending between opposite upper and lower edges and extending from the front plate proximal end to the rear plate proximal end, the distance between the front plate proximal end and the rear plate proximal end being generally commensurate with the jamb's predetermined depth, the gate stop front plate having a hole therethrough, the gate stop rear plate having a hole therethrough collinear with the front plate hole, the front and rear plate holes being adapted for alignment with the jamb's mounting hole, so as to be able to mount the gate stop on the jamb, the gate stop being molded from a polymeric material, the gate stop having a U-shaped metal insert disposed within the molded gate stop;
a latch arm extending from a proximal end to a distal end, the latch arm having a front aspect and an opposite rear aspect, the latch arm having a knob projecting outward from the front aspect at the distal end for manual grasping, the latch arm having a button projecting outward from the rear aspect at the distal end for contact with the gate, the knob projecting outward further than the button, the latch arm being reversible so as to accommodate different size jambs, the proximal end having a hole therethrough, the hole being adapted to pivotally mount the latch arm on the gate stop front plate for pivotal movement of the latch arm from a generally upright latch open position wherein the gate will be free to open, to a generally lateral latch closed position wherein the gate will be captured between the latch arm and the gate stop rear plate, the front plate and the latch arm having mutually opposed mating faces, one of the mating faces having a ridge molded in, and the opposed of the mating faces having at least one groove molded in, the groove being adapted to receive the ridge, so as to hold the latch arm in one of the generally upright and generally lateral positions, the latch arm being molded from a polymeric material, the latch arm having a metal insert disposed within the molded latch arm; and
pivotal means for pivotal mounting of the latch arm proximal end on the gate stop front plate.

29. The gate latch of claim 28, wherein the pivotal means further comprises a threaded fastener adapted for passing through the latch arm hole and the gate stop front plate hole and the jamb's mounting hole and the gate stop rear plate hole, so as to pivotally fasten the latch arm to the gate stop front plate and to fasten the gate stop to the jamb.

30. The gate latch of claim 28, wherein the gate stop polymeric material and the latch arm polymeric material are selected from the group consisting of thermoplastic resins and thermoset resins.

31. The gate latch of claim 28, further comprising:
the latch arm mating face having the ridge molded in adjacent the proximal end, the ridge extending radially outward from the hole; and
the gate stop front plate mating face having the groove molded in, the groove extending radially outward from the hole, and adapted to receive the latch arm ridge so as to hold the latch arm in position.

32. The gate latch of claim 28, further comprising:
the gate stop front plate mating face having the ridge molded in, the ridge extending radially outward from adjacent the front plate hole; and
the latch arm mating face having the groove molded in adjacent the proximal end, the groove extending radially outward from adjacent the latch arm hole, and adapted to receive the front plate ridge so as to hold the latch arm in position.
